(19) United States
(12) Patent Application Publication
(10) Pub. No.: US 2025/0158897 A1
(43) Pub. Date: May 15, 2025

(54) AUTOMATED DEVICE MANAGEMENT

(71) Applicant: Microsoft Technology Licensing, LLC, Redmond, WA (US)

(72) Inventors: Eshan Mathur, Los Angeles, CA (US); Christian Schacht, Seattle, WA (US); Srikanth Venkataramana Palla, Sammamish, WA (US); Danilo Perez Solano, Kenmore, WA (US); Muhammad Inam Haider, Surrey (CA); Harshit Bhandari, Ontario (CA); Anup Rao, Buford, GA (US); Sagar Suresh Naware, Dublin, CA (US)

(21) Appl. No.: 18/611,389

(22) Filed: Mar. 20, 2024

Related U.S. Application Data
(60) Provisional application No. 63/599,410, filed on Nov. 15, 2023.

(51) Int. Cl. H04L 41/22; H04L 41/12

(52) U.S. Cl. CPC H04L 41/22; H04L 41/12

(57) ABSTRACT

Disclosed in some examples are methods, systems, and machine-readable mediums to provide for automated ad-hoc meeting room management. The disclosed systems may leverage the communication application executing on the participant computing devices of participants of the communication session to report information about connected peripheral devices to a management service, such as a communication service. Peripheral devices may then be assigned, either automatically or via manual assignment to a particular conference room. Various management actions may then be performed on those devices.

### PRIORITY CLAIM

This patent application claims the benefit of priority, under 35 U.S.C. Section 119 to U.S. Provisional Patent Application Ser. No. 63/599,410, titled “Automated Device Management,” filed on Nov. 15, 2023, which is hereby incorporated by reference herein in its entirety.

### TECHNICAL FIELD

Embodiments pertain to automated device management. Some embodiments relate to automated device management using computing device applications of users.

### BACKGROUND

Meeting rooms may be managed and unmanaged. Managed meeting rooms may be managed by a dedicated meeting room management device, such as a Microsoft Teams Room® device that stays in the meeting room. These devices, also called dedicated compute devices or dedicated high compute devices, provide dedicated hardware and software to enhance network-based communication sessions within a meeting room. These devices also connect to back-end management services, such as Microsoft Teams Room Pro Management Portal® where administrators can view: room status, room usage statistics, peripheral device issues that affect the rooms, actions required to restore rooms to a healthy status, and the like.

Unmanaged meeting rooms are meeting rooms that lack a meeting room management device. These meeting rooms may have ad-hoc peripheral devices, such as external displays, speakers, or the like. Unmanaged meeting rooms present several challenges. One major challenge is determining which devices, such as video conferencing equipment, computers, and other peripherals, are located in a particular meeting room. Another significant challenge with unmanaged meeting rooms is difficulty determining room usage and availability. With no centralized system managing these rooms, administrators do not have an accurate view of whether a room is currently occupied or free. There is also no data on how often rooms are utilized, making it difficult to optimize room schedules, layouts, budgets, and optimize meeting room deployments.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system 100 for facilitating a network-based communication session between multiple participant computing devices according to some examples of the present disclosure.

FIG. 2 illustrates a flowchart of a method 200 of managing devices of a conference room according to some examples of the present disclosure.

FIG. 3 shows a drawing of a GUI 300 of a network-based communication session according to some examples of the present disclosure.

FIG. 4 shows a drawing of a second GUI 400 of a network-based communication session according to some examples of the present disclosure.

FIG. 5 is a block diagram illustrating an example of a machine upon which one or more embodiments may be implemented.

FIG. 6 illustrates a flowchart of a method for automated remote peripheral device management according to some examples of the present disclosure.

### DETAILED DESCRIPTION

Due to the ad-hoc nature of unmanaged meeting rooms, the rich information about room usage, problem reports, and customized settings that are associated with managed meeting rooms are not available to information technology administrators. Instead, administrators must manually track and maintain devices within these unmanaged meeting rooms. This may include tediously entering device details into asset databases, continually testing devices, physically traveling to observe meeting room usage, and reacting to user complaints. Additionally, these unmanaged rooms are not linked with meeting software and so usage data for these rooms and problem reports for peripherals are not available to these administrators for these rooms. The lack of this information wastes time, computing resources (e.g., by having to maintain separate asset tracking and management systems), and money. For example, by not having a full picture of which rooms are utilized and which rooms are not utilized, administrators may not adequately shift resources from rooms that are not used regularly to rooms that are overused. Finally, because the unmanaged rooms are not managed, there is no centralized system that provides administrators a way to optimize a network-based communication service experience for the particular devices that are present in the meeting rooms.

Disclosed in some examples are methods, systems, and machine-readable mediums to provide for automated ad-hoc meeting room management. The disclosed systems may leverage the communication application executing on the participant computing devices of participants of the communication session to report information about connected peripheral devices to a management service, which may be part of a communication service. Peripheral devices may then be assigned, either automatically or via manual assignment, to a particular conference room. Once the devices are assigned to a conference room, the system may then infer that the conference room is being used for communication sessions held while the peripheral device is connected to a participant computing device.

Metadata (such as statistics) for the online communication session held while a device is connected to a room-assigned peripheral may also be associated with the assigned room. Furthermore, based upon the assignment of one or more devices to a room and the connection of a participant computing device to the one or more devices, the communication application can customize one or more settings (e.g., change from a private stage view to a presenter stage view) of the communication session. For example, room-specific device profiles, GUI layouts, and the like may be automatically applied.

In some examples, to prevent devices the user connects to their device at home or in a non-conference room setting from being assigned to conference rooms, various techniques may be utilized alone or in combination. In some examples, the system may not assign devices to conference rooms unless multiple different participant computing devices have connected to them (e.g., within a specified time period). That is, a device in a conference room is likely to be connected to multiple different computing devices. In some examples, the system may not assign the peripheral device to a room unless different participant computing devices that have different user accounts logged into them connect to the peripheral device (e.g., within a specified time period). This prevents a user's device from being associated with a conference room if, say, the user has multiple participant computing devices (such as multiple laptops).

In other examples, the system may also, or instead, utilize a coarse location (e.g., through an IP address to physical address lookup) of the participant computing device to prevent associating a user's personal devices to a conference room. For example, the system may only associate peripheral devices with a room when the communication applications detects that the participant computing device is at, or near (e.g., within a threshold distance) a location that is on an allowed list of locations or detects that the participant computing device is at, or near (e.g., within a threshold distance) a location that is not on a list of excluded locations. The coarse location may be or be calculated using IP addresses. For example, the IP address may map to a location and if the location is on the allowed list, or not on an exclusion list, the system may associate connected peripherals to a room. In other examples, the system may have a list of IP addresses, or IP address ranges that are associated with specific work-related locations. If the system determines that the IP address is on the list of, or within the range of, work-related IP addresses, the system may then obtain device information for devices connected to the computing device. In some other examples, peripheral devices may be auto-associated to rooms based upon user input from the participant computing device. For example, the communication application may prompt the user to input a location.

As noted, in some examples, the room assignment of the peripheral may be automatically determined. For example, if a first peripheral device that is not associated with a room is connected to a participant computing device at a same time (e.g., during a same communication session) that a second peripheral device that is assigned to a particular room is connected to the participant computing device, the second peripheral device may be assigned automatically to the particular room.

In other examples, automatic assignment may utilize room information included by organizers of one or more network-based communication sessions in one or more invite messages. For example, the meeting invite may include one or more conference room locations. Other examples may use location-based positioning of computing devices at the time of connection, such as Wi-Fi based positioning, GPS-based positioning, or the like. In still other examples, explicit user input by an administrator may be utilized to identify the room.

As described, once the room is assigned to a peripheral device, network-based communication sessions that occur on a participant device whilst connected to the peripheral device may be associated to the assigned room. Thus, metadata about the communication session may be tagged to that room. Communication session metadata refers to data generated and collected in relation to a communication session (such as a teleconference). This can include quantitative metrics and qualitative information about the meeting such as the duration of the meeting, start and end times, number of participants, identifiers for participants (name, email, IP address, etc.), roles or designations of participants (host, presenter, attendee, etc.), meeting software and services used, quality metrics (bandwidth, resolution, latency, packet loss, etc.), media types shared or transmitted (video, audio, screen share, etc.), chat or messaging logs, recording status, encryption status, connection types (wired, WiFi, cellular, etc.), device types and models, operating systems, geographic location of participants (country, city, etc.), status (including whether the peripheral is working properly) of peripherals, and the like. The communication session metadata may provide detailed technical and usage information that can be analyzed to improve performance, track usage patterns, monitor quality of service, audit compliance, and derive other business intelligence.

This metadata may then be aggregated such that it provides administrators with usage information and statistics (e.g., total use within specified time periods) of the conference room, when the conference room was in use, the quality of meetings held in the conference room, media shared in the conference room, and the like. In some examples, where multiple peripherals assigned a same conference room are connected to a same or different participant computing device, the metadata collected may be de-duplicated such that a same network-based communication session is not double counted.

As used herein, a participant computing device may be a computing device brought by a participant into a meeting, such as a laptop, tablet, or smartphone. This device may contain the user's data, credentials, and installed software. The user interacts with any shared meeting room equipment through their participant computing device. A peripheral device may be any external hardware device or equipment in a meeting room that users can connect their participant computing devices to and share, such as displays, projectors, conferencing gear, printers, cameras, speakers, microphones, etc. These shared peripherals enable presentation of information from a user's participant computing device and facilitate collaboration and communication between participants. They may be communal resources available in the meeting space. While the disclosure herein may refer to a conference room, or room, it will be appreciated by one of ordinary skill in the art that other locations—both larger and smaller than a room, may be utilized. Examples include open space areas, desks, buildings, or the like.

A network-based communication session refers to any network-based interaction between two or more users that is facilitated through internet or network connectivity. This may comprise various modes of communication, including online meetings, which are synchronous conferences held over a network that connect remote participants through capabilities like audio, video, screen sharing, and other collaboration tools, whether through dedicated meeting software or web-based platforms. It also comprises video calls, which are communications focused specifically on video transmission between participants, enabling face-to-face virtual interactions in both one-on-one and group settings. Another form of network-based communication is voice calls, or audio-only communication sessions conducted over a network, also referred to as internet telephony, web calling, or VOIP (Voice over Internet Protocol). Additionally, network-based communication sessions may comprise chats, which are direct messaging services that allow users to exchange text, image, video and file messages in real-time through an application or web interface, like instant messaging and conversational chat platforms.

The present disclosure thus solves the technical problems resulting from the lack of data regarding unmanaged ad-hoc meeting room setups using the technical solution of utilizing applications executing network-based communication sessions on participant computing devices that are brought to the unmanaged meetings by participants. These communication applications report on the unmanaged peripherals in the room to a management service. As previously described, technical problems resulting from the lack of metadata about unmanaged ad-hoc meeting room setups include unreported audio-visual problems, peripherals that are not working, a lack of information and knowledge about room usages and scheduling, and the like.

The present disclosure provides an unconventional technological solution to the problem of unmanaged peripheral devices by utilizing a network-based communication application to centrally manage distributed peripheral devices. This eliminates the need for dedicated management devices, reducing costs and computing resources. The disclosure thus improves the functioning of the computer system to add capabilities of peripheral device management. In addition, by utilizing rule-based transformations, it allows participant computing devices to modify their presentation of the network-based communication session, according to automated rule-based transformations that factor in a user's preferences, the equipment in the meeting room, and administrator settings to produce a more optimal meeting experience for users.

A person of ordinary skill in the art with the benefit of the present disclosure will appreciate that while management of peripherals in conference rooms is discussed herein, the techniques and devices described herein may be used to manage other spaces, such as hotdesking spaces, open spaces, public spaces, or the like.

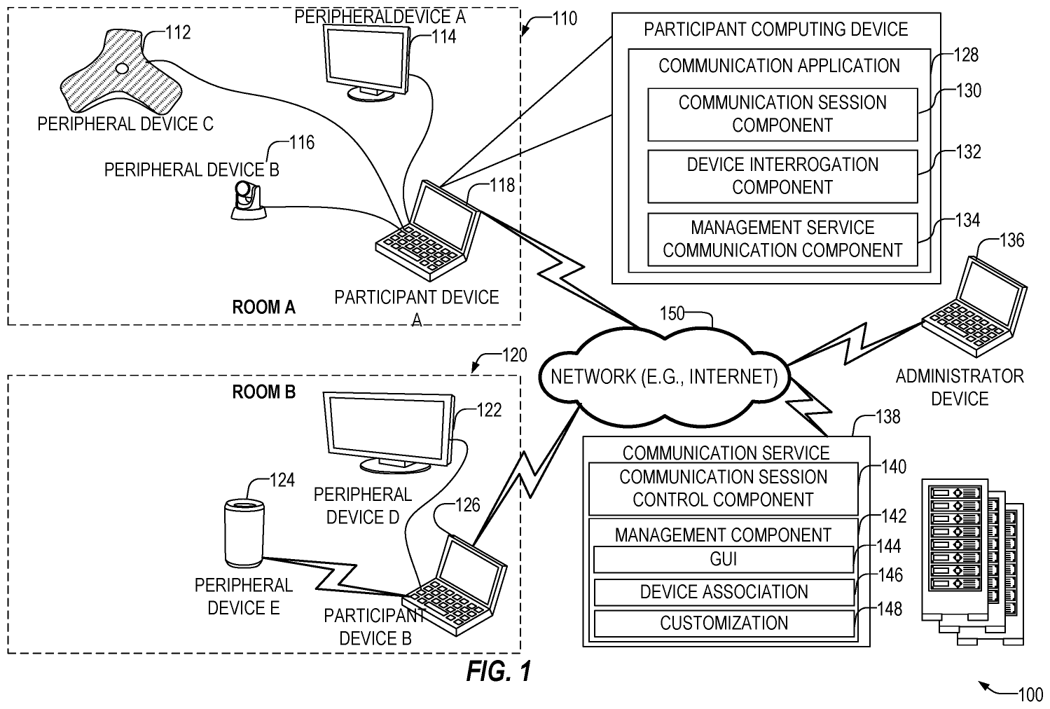

FIG. 1 illustrates a system 100 for facilitating a network-based communication session between multiple participant computing devices according to some examples of the present disclosure. The system includes conference room A 110 and conference room B 120, which can accommodate participants of the communication session. A person of ordinary skill in the art will appreciate that two conference rooms are exemplary and more or fewer conference rooms may be utilized.

In some examples, conference room A 110 may include various stand-alone peripheral devices. These devices may be unmanaged devices prior to deployment of the techniques described herein and may become managed using the techniques described herein. An unmanaged device is any device used for the purposes of engaging in the network-based communication session that is not managed by a central service, such as a management component 142 of the communication service 138. A managed device refers to an electronic device that is configured, monitored, and/or controlled by centralized management software over a network connection.

As shown, conference room A 110, includes peripheral device C 112 which is a speaker and microphone, peripheral device B 116 which is a pan-tilt-zoom camera which can capture video of the participants, and peripheral device A 114 which is an external display. As shown, conference room B contains peripheral device E 124, which is a speaker, and peripheral device D 122, which is an external display. Participant computing device A 118, and participant computing device B 126 are connected to one or more of these devices—as shown by the lines. Example connections include various wired and wireless connections such as Universal Serial Bus (USB), Bluetooth, Ethernet, Wi-Fi (e.g., Wi-Di), and the like.

Participant computing device A 118 and participant computing device B 120 are computing devices operated by participants of the communication session. Each participant computing device executes an instance of a communication application, such as communication application 128 which enables participation in the communication session. As used herein, an application instance refers to a particular launched copy of an application that has its own isolated process, memory, and state. Multiple instances of the same application may run independently on a device and a same application may have different instances on different devices.

The communication application, such as communication application 128 may include a communication session component 130 which handles the core functionality for joining and interacting in the online meeting. For example, the communication session component 130 performs client-side operations to enable each participant to join and interact in the online meeting. This includes capturing audio and video from the user's camera and microphone, encoding the streams, and transmitting them to other participants. Communication session component 130 may also receive the audio/video streams from other participants and decode and render them for presentation to the user. Other functionality enabled by the communication session component 130 includes facilitating screen sharing or content presentation with other participants. Communication session component 130 may encode the screen or content and send it to the communication session control component 140 for distribution. In addition, the communication session component 130 may also receive shared content from other participants and render it to output devices such as a display (e.g., an attached, or an external display such as peripheral device A 114, or peripheral device D 122 as per a device configuration) or a speaker (such as an attached, or external speaker such as the speaker in peripheral device C 112 and peripheral device E 124). Additionally, the communication session component 130 provides an interactive user interface (e.g., a GUI) for the user to control the meeting. This can include features like muting/unmuting audio, starting/stopping video, screen sharing controls, chat messaging, raising hand, Q&A controls, etc.

The device interrogation component 132 detects when one or more devices such as peripheral devices A, B, C, D or E are connected to the participant computing device. It then communicates with that connected device to obtain information about it such as one or more of: model number, serial number, firmware version, hardware specifications (e.g. processor speed, memory capacity, ports, etc.), network address, device capabilities (e.g. input/output modes, supported protocols, etc.), current configuration settings, operational status and metadata, usage history, device manufacturer, and/or device type/category. The device interrogation component 132 uses various protocols and interfaces to probe the connected device for these details. For example, it may use Universal Serial Bus (USB) protocols, Bluetooth protocols, Universal Plug and Play (UPnP), Simple Network Management Protocol (SNMP), and other standards and protocols to discover device information. The device interrogation component 132 logs and records the details it collects about each connected device. This device inventory data can then be used by other components of the system, such as to customize the user interface or optimize interoperability with the connected device during the communication session.

The management service communication component 134 facilitates communication of device data between the participant computing device and the communication service 138. The management service communication component 134 receives the device inventory and connection data collected by the device interrogation component 132. The management service communication component 134 then transmits this data over the network to the management component 142 located in the communication service 138. This allows the communication service to maintain a central repository of device information for all connected participant computing devices. The management service communication component 134 also receives, processes, and applies, device association and customization data from the management component 142 in the communication service 138. In addition, the management service communication component 134 may track communication metadata and provide this to the communication service 138.

The participant computing devices communicate with each other, e.g., via the communication service 138 over a network 150, (e.g., the Internet or other network). The communication service 138 may be hosted on one or more computer servers. The communication service 138 includes a communication session control component 140 which facilitates establishment and management of the online meeting. For example, it handles user authorization and authentication when joining the meeting. It also takes the media streams from each client and distributes them to other participants. This includes mixing audio sources, creating composite video layouts, and broadcasting shared content. The communication session control component 140 also provides session management functions like tracking connected users, enforcing meeting policies, recording the session, and generating analytics. It helps ensure a smooth and synchronized communication session across all participating client devices.

The communication service 138 is shown with a management component 142 that manages peripheral devices and conference rooms. While the management component 142 is shown as part of the communication service 138, one of ordinary skill in the art with the benefit of the present disclosure will appreciate that the management component 142 may be a stand-alone service. Management component 142 may include a device association component 146 that receives the device information from the management service communication component 134. The device association component 146 records information about which participant computing devices connect to which peripheral devices—e.g., in a data store. The device association component 146 may then determine that a device is ready to associate or assign to a room or other location. For example, by the application of one or more rules. Example rules include checking that one or more of: the connection(s) happened in certain locations or did not happen in certain locations, that multiple different devices have connected to a same device, and/or the like.

Once the device meets the criteria for room assignment, the device may be assigned to a room through manual or automated methods. In some examples, conference rooms may be setup and labeled; and devices manually assigned to rooms; by an administrator device, such as administrator device 136 through a management GUI provided by GUI component 144. An administrator may log into the GUI and be provided a list of peripheral devices that are ready for assignment to rooms. The administrator may view, through the GUI, details about the device, details about the connection to the device, other devices connected at a same time or near same time, and the like. The administrator may then select a room that the device is to be assigned to.

In other examples, automated association of devices to rooms may use location data in calendar meeting invites to automatically associate devices with rooms. If a user connects the participant computing device to a peripheral device while attending a meeting where the invite includes room A, that peripheral device can be assigned to room A by the device association component 146. Meeting information such as locations may be determined by the device association component 146 by utilizing the meeting data structure in the communication service 138, or it may be sent by the management service communication component 134 of the participant computing device. In some examples, if the participant computing device connects to multiple devices, and one or more of the devices are not already associated with a conference room, but some are associated with a same conference room, then the system may automatically associate the devices not already associated with the conference room with the conference room. In some examples, this may happen on a first connection, but in other examples, this may happen only after connecting a certain number of times with other devices already associated with the room.

In some examples, the automated techniques may not automatically assign the rooms, but may instead, provide suggested rooms to the administrator for manual assignment.

The customization component 148 uses the device assignments made by the device association component 146 to customize and optimize the collaboration experience. For example, once a device is associated with a room, the system may associate metadata and information about meetings held while the device is connected with the associated room. That is, the system may log metadata about a network-based communication session that the participant computing device A 118 is participating in whilst simultaneously connected to a device associated with a conference room, such as peripheral device A 114. Example metadata includes meeting duration, meeting times, content shared during the meeting, devices used during the meeting associated with the conference room, and the like. Thus, the device association component 146 may detect a connection to a device already associated with a meeting room and associate any metadata collected about network-based communication sessions that the participant computing device 118 participates in while connected to the device with that meeting room.

Management component 142 may aggregate the metadata such that the management component 142 may provide management information about conference rooms where there is no dedicated management device by using the communication application of a participant computing device, such as participant computing device A 118 or peripheral computing device B126 as a management device. Customization component 148 may also provide one or more GUIs to an administrator (e.g., through an administrator device 136) that allows the administrator to view and modify peripheral information, assignments (e.g., which devices are assigned to which rooms), raw metadata information, filtered metadata information (e.g., based upon user-defined filters), aggregated metadata information (e.g., metadata information that is aggregated across multiple network-based communication sessions related to one or more rooms), and the like. In some examples, the aggregated metadata information may be de-duplicated if a same meeting is reported twice (e.g., because multiple peripherals are connected during a same meeting). This allows the management component 142 to provide metadata such as usage metadata, what times the room was used, what devices are used, what devices are in the room, which devices need maintenance, and the like.

In addition, the customization component 148 may customize the in-meeting experience of the participant computing devices during a meeting in the conference room. For example, by applying one or more rules that factor in a user's preferences, administrator defined optimized device profiles, and the like. The optimized device profiles may include an optimized audio, video, or screen sharing profiles. For example, if the participant computing device is connected to an external display, the GUI of the communication session displayed on the external display may be changed to an external presentation view that hides notifications, menus, and other non-communication-related content and is optimized for the display size of the peripheral.

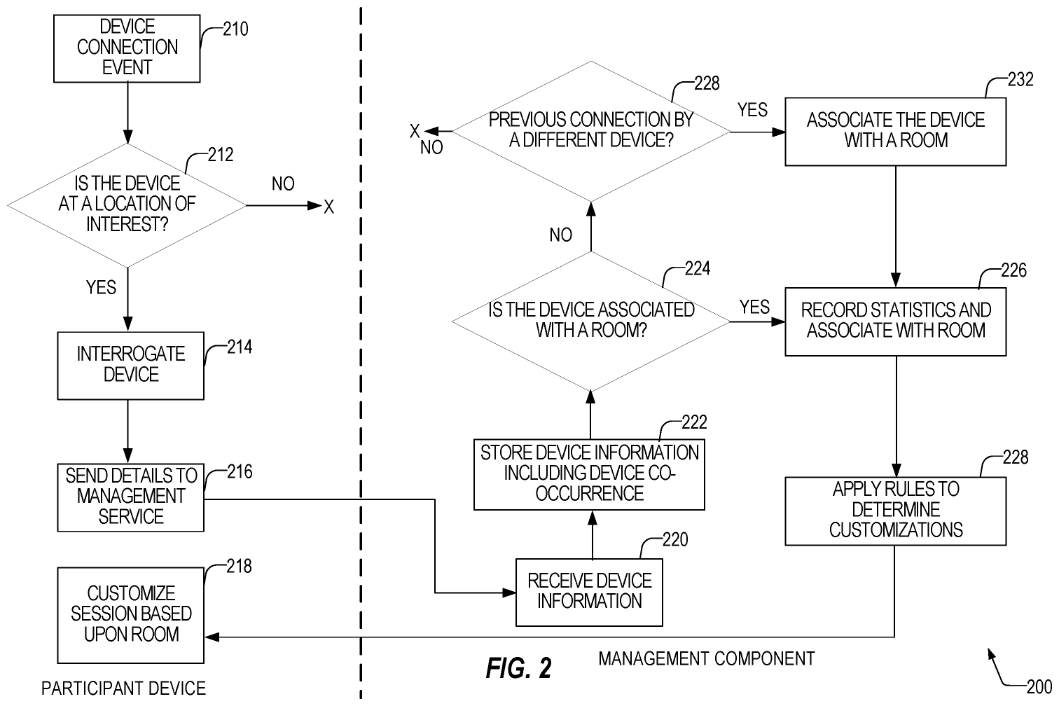

FIG. 2 illustrates a flowchart of a method 200 of managing devices of a conference room according to some examples of the present disclosure. FIG. 2 shows operations performed by a participant computing device and a communications or management service. The flowchart begins with operation 210, in which the participant computing device detects a device connection event indicating an external peripheral is connected. For example, a user, executing a communication application, attaches, connects, or pairs with a peripheral device. Peripheral devices may include various input, output, network, and/or peripheral devices utilized for a network-based communication session. Example devices may include external microphones including USB or Bluetooth wireless microphones; external USB webcams or IP cameras; external speakers; external monitors, television or projectors; routers, Ethernet switches or WiFi access points; printers; external storage drives; and the like. Example methods of connection include a multitude of wired and wireless connectivity options such as Universal Serial Bus (USB) connections, including USB-A, USB-C, and Thunderbolt variants; Ethernet; Display interfaces such as High Definition Multimedia Interface (HDMI), DisplayPort, Digital Visual Interface (DVI), and Video Graphics Array (VGA); analog audio input and output may be connected using a 3.5 millimeter headphone jack; Bluetooth, such as Bluetooth 4.0 and 5.0 as well as Bluetooth Low Energy; WiFi; Near Field Communication (NFC); infrared; and the like.

At operation 212, the participant device checks if the device is at a location of interest. The location of the participant computing device may be a precise location, such as a geolocation or a coarse location, such as a building or region. A location may be determined in a number of ways, for example, by utilizing wireless signals such as Global Navigation Satellite System (GNSS) signals such as the Global Positioning System (GPS), Wi-Fi signals, or the like. In other examples, a mapping between IP addresses and locations may be used to map the network connection IP address with a location. In still other examples, the location may be based upon the meeting invitation. The check for whether the device is at a location of interest comprises determining if the location is within, or close (e.g., within a threshold distance) to a prespecified list of locations.

If the device is not at a location of interest, the method may end. If the user computing device is at a location of interest, then at operation 214, the user computing device accesses information about the peripheral device. For example, the computing device may access the information from the connection event or may separately interrogate the peripheral device, for example, by utilizing one or more protocol query messages. Once the information is ascertained, such as by receiving a response from the device, at operation 216, the user computing device sends these details to a management component, e.g., over a network. The management component may be part of a communication service or a standalone management service.

The management component may receive the device information at operation 220. The device information may include device identification information such as a manufacturer name, a model name, a model number, a serial number, a network address, and the like. The management component may ascertain communication session information that relates to a communication session that is within a threshold amount of time from the transmission of the device details. For example, an upcoming, ongoing, or just completed communication session. The communication session information may be ascertained by data included with the device information sent by the user computing device, information ascertained through the communication service (e.g., by determining the communication session by utilizing a user's calendar for the user that is logged into the user computing device), or the like.

At operation 222 the service may store the received device information. This stored information may also include device connection co-occurrence data from the participant computing device and/or other device information from other participant computing devices attending a same network-based communication session. For example, by storing the device information and/or co-occurrence data in a database. Device co-occurrence data may be used to automatically group peripheral devices together for room assignment (e.g., in a GUI provided to an administrator). In some examples, if device A is labelled as being in room X, and device B is connected to by a same computing device at a same, or similar time (e.g., within a threshold time difference), it can be inferred that both device A and B are in room X and thus device B may be assigned automatically to room X.

In some examples, the management component may already have a record of the device in a database of devices. In these examples, the service may determine if the received information matches the already stored information, or if there is updated or incorrect information about the device. For example, different participant computing devices may interrogate a peripheral device differently-based upon, e.g., an operating system that the participant computing device executes. The service may then update the stored information with the new information. If information conflicts, the conflicts may be highlighted to an administrator for resolution (e.g., to determine if the old or new information is correct).

At operation 224, the service determines if the device is already assigned to a room. If so, then at operation 226, the services collects, or begins to collect, information about the current network-based communication session (e.g., the metadata) and associates that information with the assigned room. In addition, the service may evaluate customization rules at operation 228 to determine one or more communication session customization parameters. The customizations may be determined by application of one or more of: user preferences, administrator determined or selected profiles for the specific conference room or peripherals in the room, communication session information (e.g., the number of participants), and/or a set of prespecified rules. Determined customizations may be sent to the participant computing device to cause the participant computing device to, at operation 218, provide one or more communication session customizations based upon the room the user has been identified as being in. In other examples, the customizations may be applied by, or in conjunction with the communication server (e.g., such as jitter buffer changes).

If the device is not already associated with the room at operation 224, then at operation 228, the service determines whether a previous connection was made to the same device by a different participant computing device. If a previous connection was made to the same device by a different participant computing device, then at operation 232, the service may associate the device with a particular room. This association may be automatic or manual in accordance with the techniques described herein. In addition, operations 226, 228, and 218 are performed. If a previous connection was not made to the same device by a different participant computing device, then processing may end.

As noted, by associating peripheral devices with rooms, connection by a participant computing device to a peripheral device may cause one or more customized settings to be automatically applied, or suggested, to a user of the participant computing device. The customizations may be determined based upon an application of one or more rules to one or more of: an identifier of the room, the connected peripheral device, user preferences, communication session information (e.g., the number of participants), room or peripheral device profile information, and/or the like. Additional examples of customizations include optimized user interface displays, optimized network settings (e.g., such as jitter buffer size), optimized video settings, and/or optimized audio settings. For example, each peripheral device may have a profile associated with it that has various settings that optimize the network-based communication session based upon device capabilities, room properties, and the like. These settings may be based upon administrator settings, or may be based upon frequently, or commonly used settings when connected to a particular peripheral device.

Example video customization settings may include settings related to onboard or external camera device include resolution, size, color, high dynamic range (HDR) settings, exposure settings, color settings, white balance, zoom settings, auto-focus settings, and the like. Other video settings may include settings related to an external display, such as resolution, HDR settings, refresh rates, color settings, user interface display customizations, and the like. Audio settings may include settings for on-board or external audio devices including microphones and speakers and may include microphone gain settings, noise cancellation settings, microphone array settings, audio volume, surround settings, and the like.

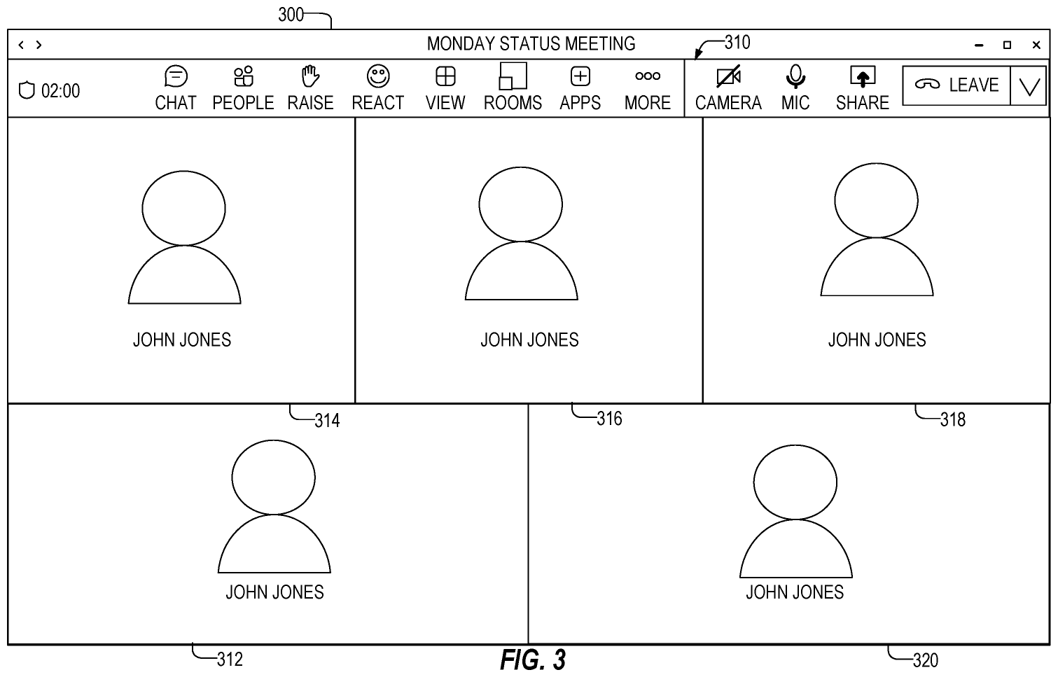

FIG. 3 shows a drawing of a GUI 300 of a network-based communication session according to some examples of the present disclosure. The GUI 300 includes a control toolbar 310 that allows a user to control one or more functions of the network-based communication session, including leaving the session, chatting, displaying a list of participants, raising a virtual hand, reacting to meeting content, changing a view configuration, creating breakout rooms, turning the camera on and off, muting and unmuting the microphone, sharing content, and the like. In the example GUI 300, panels 312, 314, 316, 318, and 320 are arranged in a grid and show video of participants, an avatar of the participant, or a picture of the participant.

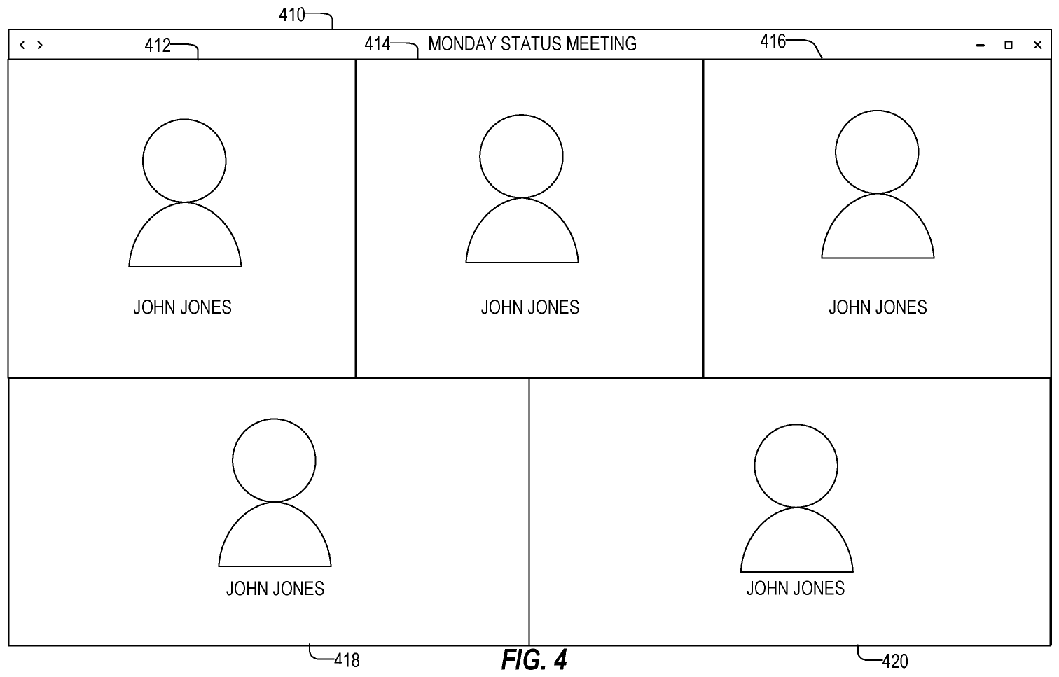

FIG. 4 shows a drawing of a second GUI 410 of a network-based communication session according to some examples of the present disclosure. The GUI 400 may be an example of a GUI customized for an external display according to some examples of the present disclosure. For example, to optimize a GUI presented on an external display, the toolbar 310 of the GUI is removed and the panels 412, 414, 416, 418, and 420 are made larger. In some examples, this may be done based upon the detection of the activation of an external display device. In other examples, this may be based upon the screen size available on the external display.

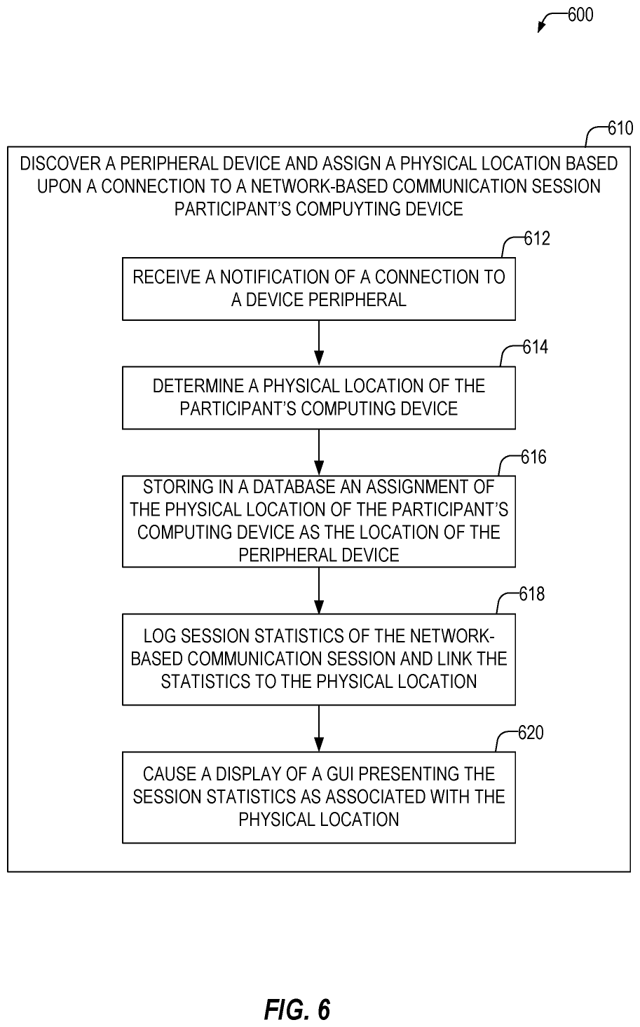

FIG. 6 presents a method 600 for automated remote peripheral device management according to some examples of the present disclosure. The method 600 illustrates the discovery and location assignment of peripheral devices in the context of network-based communication sessions.

Operation 610 is the primary process that encompasses the discovery of a peripheral device and the assignment of a physical location to it. In some examples, operations 612-620 present additional detail on how the device is discovered and linked.

Operation 612 involves the reception of a notification from a communication application running on a participant's computing device. This notification may include a unique identifier for the peripheral device, which may be used to distinguish between multiple devices. This notification may be received from the communication application before, during, or after a communication session.

At operation 614 a physical location of the participant's computing device may be determined. This determination may be made in various ways, such as analyzing the IP address of the computing device, using Wi-Fi triangulation, or even referencing the location data provided by the participant during the communication session. In other examples, the physical location may be determined using configuration settings entered by an administrator, such as a location entered by an administrator in a GUI responsive to receiving the notification at operation 612.

At operation 616 the physical location of the assignment of the physical location to the peripheral device is stored in a database, utilizing the unique identifier of the peripheral device as a reference key. This storage may establish a link between the peripheral device and its assigned physical location, which can be used for asset management and tracking within an organization. Communication sessions that involve use of the peripheral device may have statistics related to that session assigned to that location. Those statistics may be aggregated to provide a comprehensive view of the location's usage for network-based communication sessions.

At operation 618, session statistics of the network-based communication session may be logged. These statistics may include the duration of the session, the number of participants, the types of media shared, and any issues encountered with the peripheral devices. By linking these statistics to the physical location, the system creates a rich dataset that can inform future decisions regarding room utilization and peripheral device maintenance.

At operation 620 the system may cause a display of a GUI presenting the session statistics associated with the physical location. In some examples, the GUI may be caused to be displayed by sending of one or more GUI descriptions to another computing device. In other examples, the GUI may be caused to be displayed by rendering the GUI on a display communicatively coupled to the computing device.

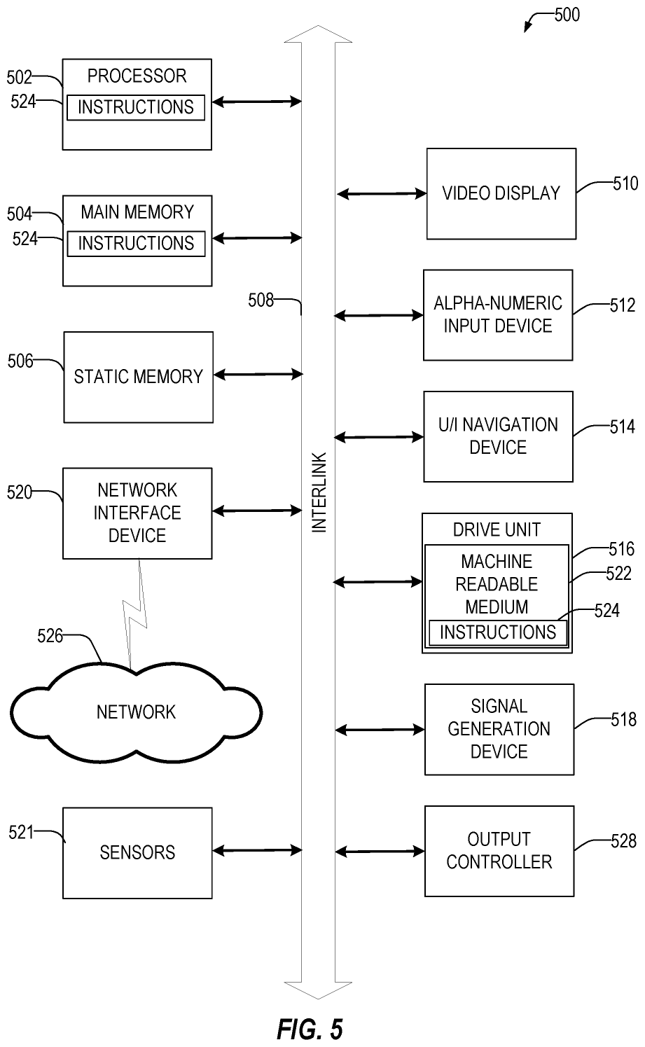

FIG. 5 illustrates a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be in the form of a server computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 500 may be or implement any of the devices of FIG. 1, the components of the participant computing device 118, the components of the communication service 138, the methods of FIGS. 2 and 6, and the GUIs of FIGS. 3 and 4.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 500 may include one or more hardware processors, such as processor 502. Processor 502 may be a central processing unit (CPU), a graphics processing unit (GPU), a hardware processor core, or any combination thereof. Machine 500 may include a main memory 504 and a static memory 506, some or all of which may communicate with each other via an interlink (e.g., bus) 508. Examples of main memory 504 may include Synchronous Dynamic Random-Access Memory (SDRAM), such as Double Data Rate memory, such as DDR4 or DDR5. Interlink 508 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a computing device for automated device management comprising a processor and a memory device, the memory device storing instructions, which when executed by the processor, cause the computing device to perform operations comprising during a communication session, receiving an indication that a participant computing device has connected to a peripheral device, the indication including device information comprising a peripheral device identifier, the indication sent by a first instance of a communication application providing a communication session and executing on the participant computing device; determining whether an entry exists in a database for the peripheral device that associates the peripheral device with a geographic place; responsive to determining that the entry does not exist in the database for the peripheral device, recording the device information: identifying a geographic place; recording an association between the geographic place and the peripheral device in the database; recording metadata regarding the communication session; associating the metadata with the geographic place in the database; determining an in-session communication parameter change for the first instance of the communication application based upon the association between the geographic place and the peripheral device; and causing the in-session communication parameter change.

In Example 2, the subject matter of Example 1 includes, wherein the operations further comprise providing a graphical user interface (GUI) displaying the metadata.

In Example 3, the subject matter of Examples 1-2 includes, wherein the in-session communication parameter change comprises a selection of a GUI format.

In Example 4, the subject matter of Examples 1-3 includes, wherein the operations of identifying a geographic place comprise providing a GUI to an administrator device and receiving a selection of the geographic place from the GUI.

In Example 5, the subject matter of Examples 1-4 includes, wherein the operations of identifying a geographic place comprise identifying the geographic place from a place field in a meeting invite request for the communication session.

In Example 6, the subject matter of Examples 1-5 includes, wherein the peripheral device comprises one of: a speaker, an external display, or a microphone.

In Example 7, the subject matter of Examples 1-6 includes, wherein the operations further comprise during a second communication session, receiving a second indication that a second participant computing device has connected to the peripheral device, the indication including the peripheral device identifier, the indication sent by a second instance of the communication application providing a communication session and executing on the second participant computing device; responsive to receiving the second indication, recording second metadata regarding the second communication session; and associating the second metadata with the geographic place in the database.

In Example 8, the subject matter of Examples 1-7 includes, wherein the operations further comprise aggregating the metadata and second metadata to create aggregated metadata, and providing the aggregated metadata to an administrator computing device in a GUI that associates the aggregated metadata with the geographic place.

In Example 9, the subject matter of Examples 1-8 includes, wherein the operations further comprise during a second communication session, receiving a second indication that a participant computing device has connected to a second peripheral device associated with the geographic place; recording second metadata regarding the second communication session; and associating the second metadata with the geographic place in the database.

In Example 10, the subject matter of Examples 1-9 includes, wherein the operations further comprise aggregating the metadata and second metadata to create aggregated metadata and providing the aggregated metadata to an administrator computing device.

In Example 11, the subject matter of Examples 1-10 includes, wherein the operations further comprise during the communication session, receiving an indication that the participant computing device has connected to a second peripheral device, the indication including a second device identifier; determining whether an entry exists in a database for the peripheral device that associates the peripheral device with the geographic place; and responsive to determining that the entry does not exist in the database for the peripheral device, recording an association between the geographic place and the peripheral device in the database.

In Example 12, the subject matter of Examples 1-11 includes, wherein the operations further comprise recording second metadata regarding the communication session; associating the second metadata with the geographic place in the database; and de-duplicating the metadata and the second metadata to create de-duplicated metadata.

In Example 13, the subject matter of Examples 1-12 includes, wherein the operations further comprise providing the de-duplicated metadata to an administrator computing device.

Example 14 is a method for automated device management comprising during a communication session, receiving an indication that a participant computing device has connected to a peripheral device, the indication including device information comprising a peripheral device identifier, the indication sent by a first instance of a communication application providing a communication session and executing on the participant computing device; determining whether an entry exists in a database for the peripheral device that associates the peripheral device with a geographic place; responsive to determining that the entry does not exist in the database for the peripheral device, recording the device information: identifying a geographic place; recording an association between the geographic place and the peripheral device in the database; recording metadata regarding the communication session; associating the metadata with the geographic place in the database; determining an in-session communication parameter change for the first instance of the communication application based upon the association between the geographic place and the peripheral device; and causing the in-session communication parameter change.

In Example 15, the subject matter of Example 14 includes, further comprising providing a graphical user interface (GUI) displaying the metadata.

In Example 16, the subject matter of Examples 14-15 includes, wherein the in-session communication parameter change comprises a selection of a GUI format.

In Example 17, the subject matter of Examples 14-16 includes, wherein identifying a geographic place comprises providing a GUI to an administrator device and receiving a selection of the geographic place from the GUI.

In Example 18, the subject matter of Examples 14-17 includes, wherein identifying a geographic place comprises identifying the geographic place from a place field in a meeting invite request for the communication session.

In Example 19, the subject matter of Examples 14-18 includes, wherein the peripheral device comprises one of: a speaker, an external display, or a microphone.

In Example 20, the subject matter of Examples 14-19 includes, further comprising during a second communication session, receiving a second indication that a second participant computing device has connected to the peripheral device, the indication including the peripheral device identifier, the indication sent by a second instance of the communication application providing a communication session and executing on the second participant computing device; responsive to receiving the second indication, recording second metadata regarding the second communication session; and associating the second metadata with the geographic place in the database.

In Example 21, the subject matter of Examples 14-20 includes, further comprising aggregating the metadata and second metadata to create aggregated metadata, and providing the aggregated metadata to an administrator computing device in a GUI that associates the aggregated metadata with the geographic place.

In Example 22, the subject matter of Examples 14-21 includes, further comprising during a second communication session, receiving a second indication that a participant computing device has connected to a second peripheral device associated with the geographic place; recording second metadata regarding the second communication session; and associating the second metadata with the geographic place in the database.

In Example 23, the subject matter of Examples 14-22 includes, further comprising aggregating the metadata and second metadata to create aggregated metadata and providing the aggregated metadata to an administrator computing device.

In Example 24, the subject matter of Examples 14-23 includes, further comprising during the communication session, receiving an indication that the participant computing device has connected to a second peripheral device, the indication including a second device identifier; determining whether an entry exists in a database for the peripheral device that associates the peripheral device with the geographic place; and responsive to determining that the entry does not exist in the database for the peripheral device, recording an association between the geographic place and the peripheral device in the database.

In Example 25, the subject matter of Examples 14-24 includes, further comprising recording second metadata regarding the communication session; associating the second metadata with the geographic place in the database; and de-duplicating the metadata and the second metadata to create de-duplicated metadata.

In Example 26, the subject matter of Examples 14-25 includes, further comprising providing the de-duplicated metadata to an administrator computing device.

Example 27 is a machine-readable medium, storing instructions for automated device management, which when executed by a machine, cause the machine to perform operations comprising during a communication session, receiving an indication that a participant computing device has connected to a peripheral device, the indication including device information comprising a peripheral device identifier, the indication sent by a first instance of a communication application providing a communication session and executing on the participant computing device; determining whether an entry exists in a database for the peripheral device that associates the peripheral device with a geographic place; responsive to determining that the entry does not exist in the database for the peripheral device, recording the device information: identifying a geographic place; recording an association between the geographic place and the peripheral device in the database; recording metadata regarding the communication session; associating the metadata with the geographic place in the database; determining an in-session communication parameter change for the first instance of the communication application based upon the association between the geographic place and the peripheral device; and causing the in-session communication parameter change.

In Example 28, the subject matter of Example 27 includes, wherein the operations further comprise providing a graphical user interface (GUI) displaying the metadata.

In Example 29, the subject matter of Examples 27-28 includes, wherein the in-session communication parameter change comprises a selection of a GUI format.

In Example 30, the subject matter of Examples 27-29 includes, wherein the operations of identifying a geographic place comprise providing a GUI to an administrator device and receiving a selection of the geographic place from the GUI.

In Example 31, the subject matter of Examples 27-30 includes, wherein the operations of identifying a geographic place comprise identifying the geographic place from a place field in a meeting invite request for the communication session.

In Example 32, the subject matter of Examples 27-31 includes, wherein the peripheral device comprises one of: a speaker, an external display, or a microphone.

In Example 33, the subject matter of Examples 27-32 includes, wherein the operations further comprise during a second communication session, receiving a second indication that a second participant computing device has connected to the peripheral device, the indication including the peripheral device identifier, the indication sent by a second instance of the communication application providing a communication session and executing on the second participant computing device; responsive to receiving the second indication, recording second metadata regarding the second communication session; and associating the second metadata with the geographic place in the database.

In Example 34, the subject matter of Examples 27-33 includes, wherein the operations further comprise aggregating the metadata and second metadata to create aggregated metadata, and providing the aggregated metadata to an administrator computing device in a GUI that associates the aggregated metadata with the geographic place.

In Example 35, the subject matter of Examples 27-34 includes, wherein the operations further comprise during a second communication session, receiving a second indication that a participant computing device has connected to a second peripheral device associated with the geographic place; recording second metadata regarding the second communication session; and associating the second metadata with the geographic place in the database.

In Example 36, the subject matter of Examples 27-35 includes, wherein the operations further comprise aggregating the metadata and second metadata to create aggregated metadata and providing the aggregated metadata to an administrator computing device.

In Example 37, the subject matter of Examples 27-36 includes, wherein the operations further comprise during the communication session, receiving an indication that the participant computing device has connected to a second peripheral device, the indication including a second device identifier; determining whether an entry exists in a database for the peripheral device that associates the peripheral device with the geographic place; and responsive to determining that the entry does not exist in the database for the peripheral device, recording an association between the geographic place and the peripheral device in the database.

In Example 38, the subject matter of Examples 27-37 includes, wherein the operations further comprise recording second metadata regarding the communication session; associating the second metadata with the geographic place in the database; and de-duplicating the metadata and the second metadata to create de-duplicated metadata.

In Example 39, the subject matter of Examples 27-38 includes, wherein the operations further comprise providing the de-duplicated metadata to an administrator computing device.

Example 40 is a computing device for automated remote peripheral device management, the computing device comprising: a processor; a memory device coupled to the processor, wherein the memory device stores instructions that, when executed by the processor, cause the computing device to perform operations comprising: discovering a peripheral device and assigning a physical location to the peripheral device based upon a connection to a network-based communication session participant's computing device, the discovering comprising: receiving, over a network, a notification from a communication application running on the participant's computing device indicating the connection to the peripheral device, wherein the notification includes, a unique identifier for the peripheral device, the notification associated with the network-based communication session of the communication application; determining a physical location of the participant's computing device upon receiving the notification, the physical location determined using one or more of: a location specified for the network-based communication session, location data about the participant's computing device, or configuration settings entered by an administrator; storing, in a database, using the unique identifier, an assignment of the physical location of the participant's computing device as the location of the peripheral device; logging session statistics of the network-based communication session and linking the session statistics to the physical location within the database; and cause a display of a graphical user interface that presents the session statistics as associated with the physical location.

In Example 41, the subject matter of Example 40 includes, wherein the operations further comprise: receiving, during a subsequent network-based communication session, a second notification indicating that a second participant computing device has connected to the peripheral device identified by the unique identifier; link second session statistics related to the subsequent network-based communication session to the physical location in the database based upon the previously stored assignment between the physical location and the peripheral device; combine the session statistics and the second network-based session statistics to create combined statistics; and display a graphical user interface that presents the combined statistics.

In Example 42, the subject matter of Examples 40-41 includes, wherein the operations further comprise: determining an in-session communication parameter change for the communication application based upon the determined physical location of the peripheral device; and causing the in-session communication parameter change.

In Example 43, the subject matter of Examples 40-42 includes, wherein the configuration settings comprise a location provided by an administrator through a user interface.

In Example 44, the subject matter of Examples 40-43 includes, wherein the location specified for the network-based communication session comprises a location field from an invite of the network-based communication session.

In Example 45, the subject matter of Examples 40-44 includes, wherein the operations of storing in the database, using the unique identifier, the assignment of the physical location of the participant's computing device as the location of the peripheral device is performed responsive to both the notification and a previous notification from a second instance of the communication application running on a second participant's computing device in the physical location indicating a previous connection to the peripheral device.

In Example 46, the subject matter of Examples 40-45 includes, wherein the operations further comprise: during a second communication session, receiving a second indication that a second participant's computing device has connected to a second peripheral device associated with the physical location; recording second statistics regarding the second communication session; associating the second statistics with the physical location in the database; combine the session statistics and the second session statistics to create combined statistics; and display a graphical user interface that presents the combined statistics.

Example 47 is a method for automated remote peripheral device management, the method comprising: discovering a peripheral device and assigning a physical location to the peripheral device based upon a connection to a network-based communication session participant's computing device, the discovering comprising: receiving, over a network, a notification from a communication application running on the participant's computing device indicating the connection to the peripheral device, wherein the notification includes, a unique identifier for the peripheral device, the notification associated with the network-based communication session of the communication application; determining a physical location of the participant's computing device upon receiving the notification, the physical location determined using one or more of: a location specified for the network-based communication session, location data about the participant's computing device, or configuration settings entered by an administrator; storing, in a database, using the unique identifier, an assignment of the physical location of the participant's computing device as the location of the peripheral device; logging session statistics of the network-based communication session and linking the session statistics to the physical location within the database; and causing a display of a graphical user interface that presents the session statistics as associated with the physical location.

In Example 48, the subject matter of Example 47 includes, wherein the method further comprises: receiving, during a subsequent network-based communication session, a second notification indicating that a second participant computing device has connected to the peripheral device identified by the unique identifier; linking second session statistics related to the subsequent network-based communication session to the physical location in the database based upon the previously stored assignment between the physical location and the peripheral device; combining the session statistics and the second network-based session statistics to create combined statistics; and displaying a graphical user interface that presents the combined statistics.

In Example 49, the subject matter of Examples 47-48 includes, wherein the method further comprises: determining an in-session communication parameter change for the communication application based upon the determined physical location of the peripheral device; and causing the in-session communication parameter change.

In Example 50, the subject matter of Examples 47-49 includes, wherein the configuration settings comprise a location provided by an administrator through a user interface.

In Example 51, the subject matter of Examples 47-50 includes, wherein the location specified for the network-based communication session comprises a location field from an invite of the network-based communication session.

In Example 52, the subject matter of Examples 47-51 includes, wherein the storing in the database, using the unique identifier, the assignment of the physical location of the participant's computing device as the location of the peripheral device is performed responsive to both the notification and a previous notification from a second instance of the communication application running on a second participant's computing device in the physical location indicating a previous connection to the peripheral device.

In Example 53, the subject matter of Examples 47-52 includes, wherein the method further comprises: during a second communication session, receiving a second indication that a second participant's computing device has connected to a second peripheral device associated with the physical location; recording second statistics regarding the second communication session; associating the second statistics with the physical location in the database; combining the session statistics and the second session statistics to create combined statistics; and displaying a graphical user interface that presents the combined statistics.

Example 54 is a machine-readable medium, storing instructions, which when executed by a machine, cause the machine to perform operations comprising: discovering a peripheral device and assigning a physical location to the peripheral device based upon a connection to a network-based communication session participant's computing device, the discovering comprising: receiving, over a network, a notification from a communication application running on the participant's computing device indicating the connection to the peripheral device, wherein the notification includes, a unique identifier for the peripheral device, the notification associated with the network-based communication session of the communication application; determining a physical location of the participant's computing device upon receiving the notification, the physical location determined using one or more of: a location specified for the network-based communication session, location data about the participant's computing device, or configuration settings entered by an administrator; storing, in a database, using the unique identifier, an assignment of the physical location of the participant's computing device as the location of the peripheral device; logging session statistics of the network-based communication session and linking the session statistics to the physical location within the database; and causing a display of a graphical user interface that presents the session statistics as associated with the physical location.

In Example 55, the subject matter of Example 54 includes, wherein the operations further comprise: receiving, during a subsequent network-based communication session, a second notification indicating that a second participant computing device has connected to the peripheral device identified by the unique identifier; linking second session statistics related to the subsequent network-based communication session to the physical location in the database based upon the previously stored assignment between the physical location and the peripheral device; combining the session statistics and the second network-based session statistics to create combined statistics; and displaying a graphical user interface that presents the combined statistics.

In Example 56, the subject matter of Examples 54-55 includes, wherein the operations further comprise: determining an in-session communication parameter change for the communication application based upon the determined physical location of the peripheral device; and causing the in-session communication parameter change.

In Example 57, the subject matter of Examples 54-56 includes, wherein the configuration settings comprise a location provided by an administrator through a user interface.

In Example 58, the subject matter of Examples 54-57 includes, wherein the location specified for the network-based communication session comprises a location field from an invite of the network-based communication session.

In Example 59, the subject matter of Examples 54-58 includes, wherein the operations of storing in the database, using the unique identifier, the assignment of the physical location of the participant's computing device as the location of the peripheral device is performed responsive to both the notification and a previous notification from a second instance of the communication application running on a second participant's computing device in the physical location indicating a previous connection to the peripheral device.

In Example 60, the subject matter of Examples 54-59 includes, wherein the operations further comprise: during a second communication session, receiving a second indication that a second participant's computing device has connected to a second peripheral device associated with the physical location; recording second statistics regarding the second communication session; associating the second statistics with the physical location in the database; combining the session statistics and the second session statistics to create combined statistics; and displaying a graphical user interface that presents the combined statistics.

Example 61 is at least one machine-readable medium including instructions that, when executed by processing circuitry, cause the processing circuitry to perform operations to implement of any of Examples 40-60.

Example 62 is an apparatus comprising means to implement of any of Examples 40-60.

Example 63 is a system to implement of any of Examples 40-60.

Example 64 is a method to implement of any of Examples 40-60.

What is claimed is:

1. A computing device for automated remote peripheral device management, the computing device comprising:
a processor;
a memory device coupled to the processor, wherein the memory device stores instructions that, when executed by the processor, cause the computing device to perform operations comprising:
discovering a peripheral device and assigning a physical location to the peripheral device based upon a connection to a network-based communication session participant's computing device, the discovering comprising:
receiving, over a network, a notification from a communication application running on the participant's computing device indicating the connection to the peripheral device, wherein the notification includes a unique identifier for the peripheral device, the notification associated with the network-based communication session of the communication application;
determining a physical location of the participant's computing device upon receiving the notification, the physical location determined using one or more of: a location specified for the network-based communication session, location data about the participant's computing device, or configuration settings entered by an administrator;
storing, in a database, using the unique identifier, an assignment of the physical location of the participant's computing device as the location of the peripheral device;
logging session statistics of the network-based communication session and linking the session statistics to the physical location within the database; and
cause a display of a graphical user interface that presents the session statistics as associated with the physical location.

2. The computing device of claim 1, wherein the operations further comprise:
receiving, during a subsequent network-based communication session, a second notification indicating that a second participant computing device has connected to the peripheral device identified by the unique identifier;
link second session statistics related to the subsequent network-based communication session to the physical location in the database based upon the previously stored assignment between the physical location and the peripheral device;
combine the session statistics and the second network-based session statistics to create combined statistics; and
display a graphical user interface that presents the combined statistics.

3. The computing device of claim 1, wherein the operations further comprise:
determining an in-session communication parameter change for the communication application based upon the determined physical location of the peripheral device; and
causing the in-session communication parameter change.

4. The computing device of claim 1, wherein the configuration settings comprise a location provided by an administrator through a user interface.

5. The computing device of claim 1, wherein the location specified for the network-based communication session comprises a location field from an invite of the network-based communication session.

6. The computing device of claim 1, wherein the operations of storing in the database, using the unique identifier, the assignment of the physical location of the participant's computing device as the location of the peripheral device is performed responsive to both the notification and a previous notification from a second instance of the communication application running on a second participant's computing device in the physical location indicating a previous connection to the peripheral device.

7. The computing device of claim 1, wherein the operations further comprise:
during a second communication session, receiving a second indication that a second participant's computing device has connected to a second peripheral device associated with the physical location;
recording second statistics regarding the second communication session;
associating the second statistics with the physical location in the database;
combine the session statistics and the second session statistics to create combined statistics; and
display a graphical user interface that presents the combined statistics.

8. A method for automated remote peripheral device management, the method comprising:
discovering a peripheral device and assigning a physical location to the peripheral device based upon a connection to a network-based communication session participant's computing device, the discovering comprising:
receiving, over a network, a notification from a communication application running on the participant's computing device indicating the connection to the peripheral device, wherein the notification includes a unique identifier for the peripheral device, the notification associated with the network-based communication session of the communication application;
determining a physical location of the participant's computing device upon receiving the notification, the physical location determined using one or more of: a location specified for the network-based communication session, location data about the participant's computing device, or configuration settings entered by an administrator;
storing, in a database, using the unique identifier, an assignment of the physical location of the participant's computing device as the location of the peripheral device;
logging session statistics of the network-based communication session and linking the session statistics to the physical location within the database; and
causing a display of a graphical user interface that presents the session statistics as associated with the physical location.

9. The method of claim 8, wherein the method further comprises:
receiving, during a subsequent network-based communication session, a second notification indicating that a second participant computing device has connected to the peripheral device identified by the unique identifier;
linking second session statistics related to the subsequent network-based communication session to the physical location in the database based upon the previously stored assignment between the physical location and the peripheral device;
combining the session statistics and the second network-based session statistics to create combined statistics; and
displaying a graphical user interface that presents the combined statistics.

10. The method of claim 8, wherein the method further comprises:
determining an in-session communication parameter change for the communication application based upon the determined physical location of the peripheral device; and
causing the in-session communication parameter change.

11. The method of claim 8, wherein the configuration settings comprise a location provided by an administrator through a user interface.

12. The method of claim 8, wherein the location specified for the network-based communication session comprises a location field from an invite of the network-based communication session.

13. The method of claim 8, wherein the storing in the database, using the unique identifier, the assignment of the physical location of the participant's computing device as the location of the peripheral device is performed responsive to both the notification and a previous notification from a second instance of the communication application running on a second participant's computing device in the physical location indicating a previous connection to the peripheral device.

14. The method of claim 8, wherein the method further comprises:
during a second communication session, receiving a second indication that a second participant's computing device has connected to a second peripheral device associated with the physical location;
recording second statistics regarding the second communication session;
associating the second statistics with the physical location in the database;
combining the session statistics and the second session statistics to create combined statistics; and
displaying a graphical user interface that presents the combined statistics.

15. A machine-readable medium, storing instructions, which when executed by a machine, cause the machine to perform operations comprising:
discovering a peripheral device and assigning a physical location to the peripheral device based upon a connection to a network-based communication session participant's computing device, the discovering comprising:
receiving, over a network, a notification from a communication application running on the participant's computing device indicating the connection to the peripheral device, wherein the notification includes a unique identifier for the peripheral device, the notification associated with the network-based communication session of the communication application;
determining a physical location of the participant's computing device upon receiving the notification, the physical location determined using one or more of: a location specified for the network-based communication session, location data about the participant's computing device, or configuration settings entered by an administrator;
storing, in a database, using the unique identifier, an assignment of the physical location of the participant's computing device as the location of the peripheral device;
logging session statistics of the network-based communication session and linking the session statistics to the physical location within the database; and
causing a display of a graphical user interface that presents the session statistics as associated with the physical location.

16. The machine-readable medium of claim 15, wherein the operations further comprise:
receiving, during a subsequent network-based communication session, a second notification indicating that a second participant computing device has connected to the peripheral device identified by the unique identifier;
linking second session statistics related to the subsequent network-based communication session to the physical location in the database based upon the previously stored assignment between the physical location and the peripheral device;
combining the session statistics and the second network-based session statistics to create combined statistics; and
displaying a graphical user interface that presents the combined statistics.

17. The machine-readable medium of claim 15, wherein the operations further comprise:
determining an in-session communication parameter change for the communication application based upon the determined physical location of the peripheral device; and
causing the in-session communication parameter change.

18. The machine-readable medium of claim 15, wherein the configuration settings comprise a location provided by an administrator through a user interface.

19. The machine-readable medium of claim 15, wherein the location specified for the network-based communication session comprises a location field from an invite of the network-based communication session.

20. The machine-readable medium of claim 15, wherein the operations of storing in the database, using the unique identifier, the assignment of the physical location of the participant's computing device as the location of the peripheral device is performed responsive to both the notification and a previous notification from a second instance of the communication application running on a second participant's computing device in the physical location indicating a previous connection to the peripheral device.
